(19) United States
(12) Patent Application Publication
(10) Pub. No.: US 2010/0289448 A1
(43) Pub. Date: Nov. 18, 2010

(54) Induction Charging Device

(75) Inventors: Philipp Jung, Griesheim (DE); Thomas Hohmann, Gelnhausen (DE); Alexander Hilscher, Oberursel (DE); Joachim Lepper, Usingen (DE); Winfried Ziemann, Oberursel (DE); Peter Trawinski, Weiterstadt (DE); Norbert Schaefer, Frankfurt/Main (DE); Leo Faranda, Rodgau (DE)

Correspondence Address: THE PROCTER & GAMBLE COMPANY;Global Legal Department - IP, Sycamore Building - 4th Floor, 299 East Sixth Street, CINCINNATI, OH, 45202, US

(73) Assignee: Braun GmbH, Cincinnati, OH (US)

(21) Appl. No.: 12/778,333

(22) Filed: May 12, 2010

(30) Foreign Application Priority Data
May 13, 2009 (EP) 09006444.5

(51) Int. Cl. H02J 7/00

(52) U.S. Cl. 320/108

(57) ABSTRACT

An induction charging device for charging an energy accumulator of a mobile electric device is provided. The device includes a coil for energy transmission; and a control for energy transmission. The control is connected to a capacitor with a modifiable capacitance, and the capacitor is designed such that its capacitance changes as a function of whether the mobile electric device is in a charging position or not.

### CROSS REFERENCE TO RELATED APPLICATION

This application claims the benefit of European Patent Convention Application No. 09006444.5, filed on May 13, 2009, the substance of which is incorporated herein by reference.

### FIELD OF THE INVENTION

The present disclosure relates to an induction charging device for charging an energy accumulator of a mobile electric device with a coil for energy transmission and a control for energy transmission. More particularly, the present disclosure relates to a system with an induction charging device, and a mobile electric device, as well as a process for charging an energy accumulator of a mobile electric device by means of an induction charging device.

### BACKGROUND OF THE INVENTION

Such types of energy transmission systems are used, among other things, to charge accumulators and other storage devices for electric energy in mobile electric devices. Mobile electric devices may be, for example, electric toothbrushes, electric shavers, electric handheld tools, electric kitchen appliances, electric hand-held vacuum cleaners, mobile medical devices, mobile telephones, or mobile measuring instruments of all types.

Cordless energy transmission can be realized, in particular, through inductive energy transmission. In doing so, a magnetic coil in the charging unit and a magnetic coil in the mobile electric device are coupled in a magnetically reversible manner. This results in a divisible transformer which has one coil in the charging unit in one coil in the mobile electric device. Alternating current via the coil in the induction charging device can be taken as power from the coil in the mobile electric unit.

With such type of energy transmission, the charging unit also consumes primary energy when no energy is being transmitted to a handheld device. This is disadvantageous with respect to measures for energy savings.

Thus, systems comprising induction charging devices and mobile electric devices were developed. Such systems detect the presence of the mobile electric device at the induction charging device. When the mobile electric device is not present, the induction charging device ceases to attempt energy transmission, thus minimizing energy consumption.

Various devices and processes are known from the prior art for detecting the presence of a mobile electric device. For example, EP 0 357 829 describes a system in which the presence of the mobile electric device is detected in that signals are transmitted from the electric device, via a light emitting diode, to a receiver diode in the induction charging device. If the system detects that the mobile electric device is not present on the receiver diode, the induction charging device ceases the charging activity and switches off its power supply. In addition to optical detection, the switching of REED switches or micro-switches with magnets or electromagnets in the mobile electric device as well as a combination of magnet and Hall element are described.

What many optical presence detection systems have in common is that the mobile electric device has to use a relatively large amount of current to signal its presence. Because only a limited amount of battery power is available in the mobile electric device or the charging device is further impacted, this is disadvantageous. In addition, the optical equipment is sensitive to soiling. Therefore, reliable signaling is not always ensured.

### SUMMARY OF THE INVENTION

In one embodiment, an induction charging device for charging an energy accumulator of a mobile electric device includes a coil for energy transmission; and a control for energy transmission. The control is connected to a capacitor with a modifiable capacitance, and the capacitor is designed such that its capacitance changes as a function of whether the mobile electric device is in a charging position or not.

In another embodiment, a system includes an induction charging device including a coil for energy transmission and a control for energy transmission; and a mobile electric device including a coil for energy transmission and an energy accumulator connected to the coil. The control is connected to a capacitor with a modifiable capacitance. The mobile electric device can be positioned in a charging position such that, with the assistance of the coils, energy can be transferred from the induction charging device to the energy accumulator of the mobile electric device. In addition, the mobile electric device has a mechanism which changes the capacitance of the capacitor of the induction charging device depending on whether the mobile electric device is in the charging position or not.

In another embodiment, a process for charging an energy accumulator of a mobile electric device includes comprising the steps of: providing an induction charging device with a control for energy transmission; detecting the capacitance of a capacitor of the induction charging device, which depends on the presence of the mobile electric device in the environment of the induction charging device; comparing the capacitance results with a threshold value; and activating or deactivating energy transmission between a coil of the induction charging device and the mobile electric device as a function of the results of the comparison.

### BRIEF DESCRIPTION OF THE DRAWINGS

While the specification concludes with claims which particularly point out and distinctly claim the subject matter that is regarded as the invention, it is believed the various embodiments will be better understood from the following description taken in conjunction with the accompanying drawings, in which:

FIG. 1 is a schematic representation of a first embodiment of a system comprising an induction charging device and a mobile electric device;

FIG. 2 is a schematic representation of another embodiment of a system comprising an induction charging device and a mobile electric device;

FIG. 3 is a schematic representation in accordance with another embodiment of a system comprising an induction charging device and a mobile electric device; and

FIG. 4 is a schematic representation in accordance with another embodiment of a system comprising an induction charging device and a mobile electric device.

### DETAILED DESCRIPTION OF THE INVENTION

According to the present disclosure, it is advantageous to reduce the energy consumption required for presence detection and to improve the reliability of presence detection. According to one embodiment, a device that reduces the energy consumption required for presence detection and improves the reliability of presence detection includes an induction charging device for charging an energy accumulator of a mobile electric device, with a coil for energy transmission and a control for energy transmission, wherein the control is connected to a capacitor with a modifiable capacitance, and wherein the capacitor is designed such that its capacitance changes as a function of whether the mobile electric device is in a charging position or not.

Use of the capacitive measuring technology to detect the presence of a mobile electric device is carried out with very little energy and enables reliable detection. The capacitance of a capacitor of the induction charging device is influenced by the mobile electric device so that its presence in the charging position or its absence is detected. An embodiment of a mobile electric device in a charging position in terms of the present disclosure means that, during charging operation, the electromagnetic field of the coil for energy transmission of the induction charging device also is interspersed in a coil on the mobile electric device side, so that energy from the coil of the induction charging device (transmitting coil) can be transmitted to the coil of the mobile electric device (receiving coil). This means that an arrangement in the charging position is present when the charging operation is deactivated, the mobile electric device is arranged in the environment of the induction charging device such that an electromagnetic coupling is possible between the coil of the induction charging device and the coil of the mobile electric device.

In general, the coils from the induction charging device and mobile electric device must be spatially close to one another for such a coupling or arrangement in the charging position. In one embodiment, an energy accumulator of the mobile electric device can be any type of accumulator, for example, a rechargeable battery, a storage capacitor, or any other device for storing electric energy. In one embodiment, the induction charging device is designed such that the mobile electric device can be mechanically mounted in or on it. The capacitance of the capacitor depends on whether the mobile electric device is mechanically mounted in or on the induction charging device or not.

In order to enable mechanical mounting of the mobile electric device on the induction charging device, the induction charging device, in one embodiment, has a housing with a mechanism, which latches onto a complementary mechanism on the housing of the mobile electric device, to charge the mobile electric device, or with a mechanism, onto which the mobile electric device or its housing latches and, in this manner, is held in or on the induction charging device. In one embodiment, the housing of the induction charging device is essentially designed in the shape of a ring, wherein the mobile electric device or its housing can be mounted in the ring.

In one embodiment, the control is configured such that it detects the capacitance of the capacitor during operation of the device and controls energy transmission as a function of the capacitance of the capacitor. The control may be designed such that it is provided with the measuring result of a capacitance measurement of the capacitor, which it then uses to decide whether energy transmission should be activated or not. Energy transmission is then appropriately activated when, by means of the measurement result, it can be detected that the mobile electric device is arranged in a charging position, i.e. that the mobile electric device is in the vicinity of, on, or in the induction charging device.

In one embodiment of the invention, the electrodes of the capacitor of the induction charging device are integrated into an oscillatory circuit as a frequency-influencing capacitance or integrated into a capacitance measuring circuit as measuring capacitance or influence a state of a control circuit in another manner.

In another embodiment, the capacitor has at least two electrodes, wherein a dielectric extends, at least partially, between the electrodes, and the dielectric's constant can be modified by means of exertion of a mechanical, electric, or magnetic force or by means of the effects of a field on the dielectric, wherein the force or the field depends on whether the mobile electric device is arranged in the charging position or is not. For example, the dialectic constant of the dielectric can be modified by a mechanical compression of the dielectric located between the plates.

In its simplest embodiment, a capacitor consists of at least two electrodes, between which an electric field forms when electric voltage is applied to the electrodes. The electric field is interspersed in a non-conducting dielectric. With a plate capacitor, for example, the electric field can essentially limit itself to the volume between the electrodes. Through other geometries of the electrodes it is also possible, however, for the electric field to be fairly far away from the electrodes, for example, when they are designed as parallel plates. The relevant electric field then covers an area the same order of magnitude as the plate dimensions or even vertical with respect to the surface of the plates. In this case as well, any electrically non-conductive material that is interspersed by the field lines forms the capacitor's dielectric. Therefore, in terms of the present disclosure, the dielectric of the capacitor characterizes any electrically non-conducting materials that are interspersed by the electric field of the capacitor when the induction charging device is operated. This also includes, in embodiments, those materials that are outside of the induction charging device, particularly the air and the environment and elements or sections of the mobile electric device that are placed in the environment of the capacitor.

When materials that are different from one another are basically placed in the electric field of the capacitor, the capacitance of the capacitor changes. This effect and other influences of the dielectric constants can be utilized for detecting the presence of the mobile electric device. The dielectric constant is included as a multiplicative factor in the capacitance, whereby changes in the electric constants essentially affect the capacitance proportionally.

In one embodiment, the dielectric between the plates is designed such that it is, at least partially, exchangeable, wherein the dielectric located between the electrodes depends on whether the mobile electric device is in the charging position or not. This exchange can take place, for example, in that a dielectric is placed in an air gap between the plates. In doing so, the dielectric air is replaced by another dielectric with a dielectric constant that varies depending on the air, for example, by a section of a housing of the mobile electric device. Such an exchange of the dielectric between the plates of the capacitor can also be achieved, however, in that a block comprising to dielectric materials is arranged to be moveable between the plates. The material located between the plates then has a mean dielectric constant whose value depends on what volume of space between the plates is filled and by what material.

In another embodiment, the capacitor has at least two electrodes whose relative position with respect to one another and/or whose form can be modified, wherein the relative position and/or form depends on whether the mobile electric device is in the charging position or not. One possibility for influencing the capacitance of the capacitor is to change the geometry of the electrodes. To this end, the relative position of the electrodes can be modified with respect to one another, for example, the distance of the electrodes with respect to one another can be changed or the electrodes can be moved laterally with respect to one another. Another option is to change the form of the electrodes, for example, by folding or unfolding them or by pushing parts of one electrode behind one another, so that the effective surface is changed. Such a change can be effected by the presence of the mobile electric device, which can have a special mechanism for this purpose.

In one embodiment, the induction charging device has a housing, wherein the capacitor, with at least two electrodes and one dielectric, is arranged in the housing, and wherein the housing has a deformable section, which makes it possible to exert force, from the outside, onto the dielectric or at least one of the electrodes. If, in such an embodiment, the electric device to be charged is placed into engagement with the housing of the induction charging device, a section of the housing of the mobile electric device intended for this purpose presses, for example, onto the deformable housing section of the induction charging device. The deformation of the housing section of the induction charging device leads, in turn, to a compression, for example, of the dielectric of the capacitor or even to a change in the distance between the electrodes and the capacitor.

In another embodiment, the induction charging device includes a housing, wherein the capacitor with at least two electrodes is arranged in the housing and wherein the housing is designed such that a depression, which is accessible from the exterior, is provided between the electrodes, into which a section of a mobile electric device can be placed. If the mobile electric device to be charged is arranged in the charging position, a section of the housing of the mobile electric device latches onto the depression and exchanges the dielectric air in the depression with the material of the housing section of the mobile electric device.

In another embodiment, the induction charging device has a housing and the capacitor is designed as an open plate capacitor, wherein the electric field of the capacitor extends at least partially outside of the housing when the device is in operation. An open plate capacitor means that the plates, which form the electrodes of the plate capacitor, are not parallel but rather form an angle with respect to one another. In a special case, the two plates can be parallel to one another, wherein the angle is 180°. In another special case, the electrodes are on one plane in addition. In the latter arrangement, the electric field proceeds vertically with respect to the electrode plates and extends from one electrode to the other. The field line, which proceeds from the center of the electrodes, extends at an arc with a maximum distance to the electrodes, which is the same order of magnitude as the lateral expansion of an electrode. Such a design of the capacitor means that the electric field proceeds from the housing of the induction charging device, for example, when the two electrodes are arranged next to one another on the surface of the housing of the induction charging device or at a distance below it. The mobile electric device or a section of said device is then placed, as a dielectric, in the electric field above the induction charging device; this changes the capacitance of the capacitor, whereby the presence of the mobile electric device can be detected.

Alternatively, a system comprising an embodiment of the aforementioned induction charging device and a mobile electric device is provided, wherein the mobile electric device has a coil for energy transmission and an energy accumulator connected to the coil, wherein the mobile electric device can be positioned in a charging position such that, with the assistance of the coils, energy can be transferred from the induction charging device to the energy accumulator of the mobile electric device, and wherein the mobile electric device has a mechanism, which changes the capacitance of the capacitor of the induction charging device depending on whether the mobile electric device is arranged in the charging position or not.

With such a mechanism to change the capacitance, the mobile electric device of the induction charging device can signal its presence when it is in a charging position on, in, or in the direct vicinity of the induction charging device and/or is mounted mechanically in said device. Mobile electric devices include, for example, electric toothbrushes, electric shavers, electric handheld tools, electric kitchen appliances, electric hand-held vacuum cleaners, mobile medical devices, mobile telephones, or mobile measuring instruments of all types. In one embodiment of the system, the mobile electric device has a housing, wherein the mechanism for changing the capacitance is a section of the housing, which, when the mobile electric device is arranged in the charging position, latches onto the flexible section of the housing of the induction charging device and exerts a force onto at least one electrode or a dielectric of the capacitor.

Appropriately, the mobile electric device in one embodiment has a housing, wherein the mechanism for changing the capacitance is a section of the housing, which, when the induction charging device is arranged in the charging position, is located in the electric field of the capacitor. In a further embodiment of the system, the mobile electric device has a housing, wherein the mechanism for changing the capacitance is a section of the housing, which, when the induction charging device is arranged in the charging position, latches onto a depression in a housing of the induction charging device. In yet another embodiment, the mechanism for changing the capacitance has an electrically conductive material section as a capacitive short-circuit mechanism for an electric field of the capacitor of the induction charging device. If the mobile electric device is arranged in the charging position, the electrically conductive material section is located in the electric field of the capacitor of the induction charging device.

The capacitive short-circuit mechanism can, for example, comprise a piece of metal or a piece of another electrically conductive material. If such an electrically conductive material is placed in the field of a capacitor, the field lines will be short-circuited by the capacitive short-circuit mechanism. The surfaces of the short-circuit mechanism that are the closest to the electrodes of the capacitor form one or more electrodes of the capacitive short-circuit mechanism. This electrode of the capacitive short-circuit mechanism forms an electric field to each one of the electrodes of the capacitor. Overall, the field lines are shortened by the length of the capacitive short-circuit mechanism in the field line direction in that the capacitive short-circuit mechanism is placed in the field of the capacitor, which increases the capacitance of the capacitor.

One embodiment according to the present disclosure is a plate capacitor, which is arranged in the housing of the induction charging device. The electrically conducting material section is arranged on or in the mobile electric device and is placed, for example, in a recess on the surface of the induction charging device, between the plates of the capacitor, when the mobile electric device is placed in the charging position.

According to another embodiment, an open plate capacitor is used, which is advantageously located in the vicinity of the surface of the housing of the induction charging device. In this embodiment, the capacitive short-circuit mechanism can be configured as a sheet or foil, which is arranged under or on the surface of the housing of the mobile electric device. The capacitive short-circuit mechanism is advantageously arranged in the vicinity of the surface of the induction charging device when the mobile electric device is in the charging position. An electric field forms from one of the two electrodes of the capacitor to a first section of the opposite-lying capacitive short-circuit mechanism and from a second section of the capacitive short-circuit mechanism to the second electrode lying opposite it. The capacitance of the original capacitor, which then comprises two capacitors, switched in a series, is thereby increased significantly. This can be applied, via a capacitance measurement, to detect the presence of the mobile electric device.

The measurement can be negatively impacted in that, for example, a moisture film exists on the surface of the induction charging device, before the electrodes. The electric conductivity of the moisture when the electrodes are electrically insulated, just as with a capacitive short-circuit mechanism, causes the electric field to no longer reach the mobile electric device which is arranged in the charging position or directly causes a classic short-circuit of the capacitor if the electrodes are not insulated. Therefore, it is advantageous if the electrodes of the capacitor are arranged vertically, so that moisture drains off of the electrodes and does not cause a short-circuit. Another possibility for suppressing an electric connection from moisture is the formation of a sharp step between the electrodes of the capacitor, the capillary effect of which will interrupt any existing film of moisture.

In another embodiment, the short-circuit mechanism has two electrodes, which are connected to one another in an electrically conducting manner, and which are arranged such that an electric field forms between one of the electrodes of the capacitor of the induction charging device and one electrode of the short-circuit mechanism during charging.

By means of this design, the electrodes of the short-circuit mechanism, which correspond with the electrodes of the capacitor in the induction charging device, can be very far apart from one another, without any continuous material being required between the two electrodes. Thus, the electrodes of the capacitor of the charging device can be arranged at any distance from one another. The advantage of this is that the capacitance of the capacitor of the induction charging device as such is reduced and the capacitance change is increased due to the arrangement of the mobile electric device in the charging position. In addition, the electrodes in the induction charging device can be arranged at any suitable site.

In another embodiment, the impedance of the electric connection between the electrodes of the short-circuit mechanism can be adjusted in order to transfer data between the mobile electric device and the induction charging device. For example, a switch can be arranged between the two electrodes of the short-circuit mechanism on which digital data are modulated. Data transfer can be realized, for example, in that alternating current is supplied to the first and the second electrode of the capacitor and this alternating current can flow into the electrodes of the short-circuit mechanism when there is a closed connection, while it cannot flow when the electronic switch is open.

In another embodiment, a process for charging an energy accumulator of a mobile electric device, with the assistance of an induction charging device with a control for energy transmission is provided. The process includes a first step, the induction charging device detects the capacitance of a capacitor of the induction charging device, which depends on the presence of the mobile electric device in a charging position, and, in a second step, compares the measuring results with a threshold value, and, in a third step, activates or deactivates energy transmission between a coil of the induction charging device and the mobile electric device as a function of the result of the comparison. In this manner, it is possible to only activate energy transmission when the mobile electric device is in a charging position at the induction charging device, which means that the capacitance of the capacitor changes, in comparison with the situation, in which the mobile electric device is not arranged in the charging position.

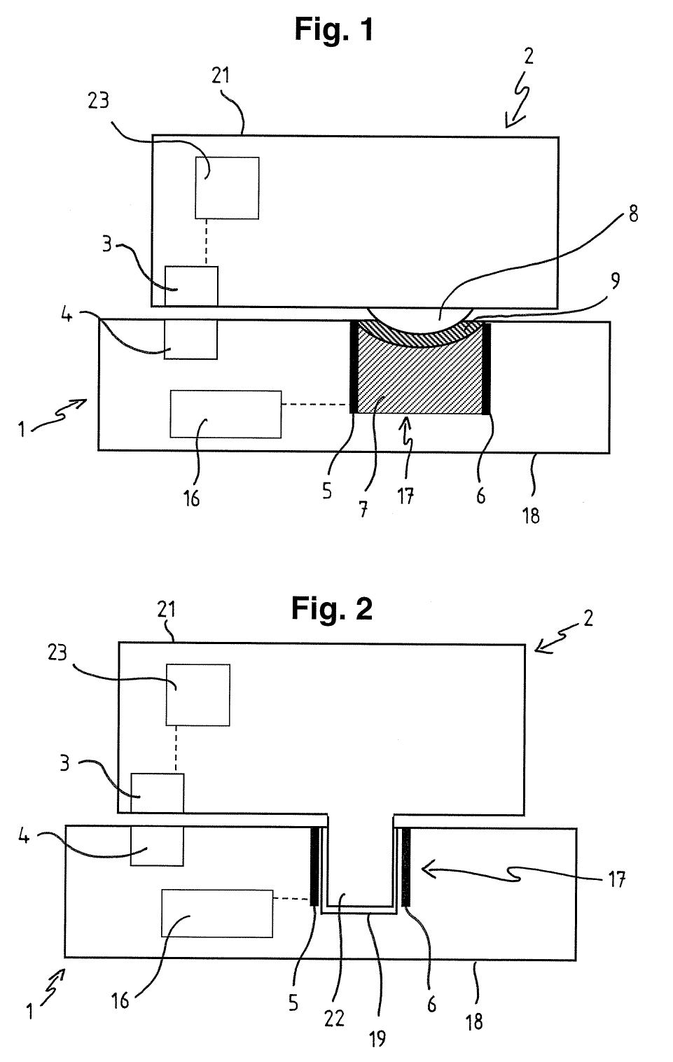

In the different embodiments from FIGS. 1 to 4, the same elements are characterized with the same reference numerals.

FIG. 1 shows a schematic representation of the induction charging device 1 and the mobile electric device 2. The housing 18 of the induction charging device 1 contains a first coil 4 for energy transmission and this coil 4 lies opposite a second coil 3 for energy transmission and the second coil 3 is arranged in the mobile electric device 2. FIG. 1 shows the mobile electric device 2 in a charging position in reference to the induction charging device 1, wherein, in this position, coils 3 and 4 are arranged such that they are coupled to one another and enable energy transmission from the induction charging device 1 to the mobile electric device 2 during operation of the device. The mobile electric device 2, which is an electric toothbrush in the embodiments shown in FIGS. 1 to 4, has an accumulator 23 connected to coil 3 for storing electric energy.

As further shown, the induction charging device 2 contains a capacitor 17, which has two electrodes, 5 and 6. A compressible dielectric 7 is arranged between electrodes 5 and 6. Depending on its density, the dielectric constant of the dielectric 7 and thus the capacitance of the capacitor 17 changes. To enable compression of the dielectric 7, the housing 18 of the induction charging device 1 has a soft area 9, which is deformable from the outside when pressure is applied.

The mobile electric device 2, in turn, has a protruding housing section 8 of the housing 21, which engages with the soft area 9 of the housing 18 of the induction charging device 1 in the charging position shown, and depresses it. Due to the depressing of the soft area 9, the capacitor's 17 dielectric 7 located directly under the soft area 9 is compressed and changes its capacitance. The dielectric 7 lies on a counter-support on its side facing away from the mobile electric device 2 in order to enable compression. A control 16 is connected to the capacitor 17 and detects the change of the capacitance as compared to a condition in which the electric toothbrush 2 is not held in the charging position and then only switches the charging activity on when the toothbrush 2 is in the charging position.

Alternatively, the dielectric 7 could be partially pushed out of the volume between the capacitor plates, 5 and 6, of the capacitor due to pressure on the soft area 9 (not shown in FIG. 1), whereby the capacitance of the capacitor 17 also changes. The pushing out of the dielectric 7 can occur, in particular, against pre-tensioning (possibly realized by a spring), so that the dielectric 7 is pushed back into its original position after the electric toothbrush 2 is removed from the charging position. In one embodiment, to prevent damage to the soft area 9, the housing protrusion 9 is designed as a spherical section. In another embodiment, the distance of the capacitor plates, 5 and 6, may be smaller than their lateral expansion. This embodiment increases the capacitance of the capacitor thereby making it easier to measure.

FIG. 2 shows an embodiment of the system comprising an induction charging device 1 and a toothbrush 2, in which the housing 21 of the electric toothbrush 2 has a housing protrusion 22 comprising plastic material, which extends, when the toothbrush 2 is in the charging position as shown, into a recess that is complementary to the protrusion 22 or into a depression 19 in a housing 18 of the induction charging device 1. The depression 19 and thus the housing protrusion 22 are arranged between the capacitor plates, 5 and 6, of the induction charging device 1. The depression 22 is filled with air when the mobile electric device 2 is not being held on the induction charging device 1 for charging. If the housing protrusion 22 between the capacitor plates, 5 and 6, is placed in the depression 19, it replaces the air, whereby the dielectric constant of the capacitor 17 changes. Placement of the housing protrusion 22 as a mechanism 8 for changing the capacitance between the capacitor plates, 5 and 6, also changes its capacitance accordingly.

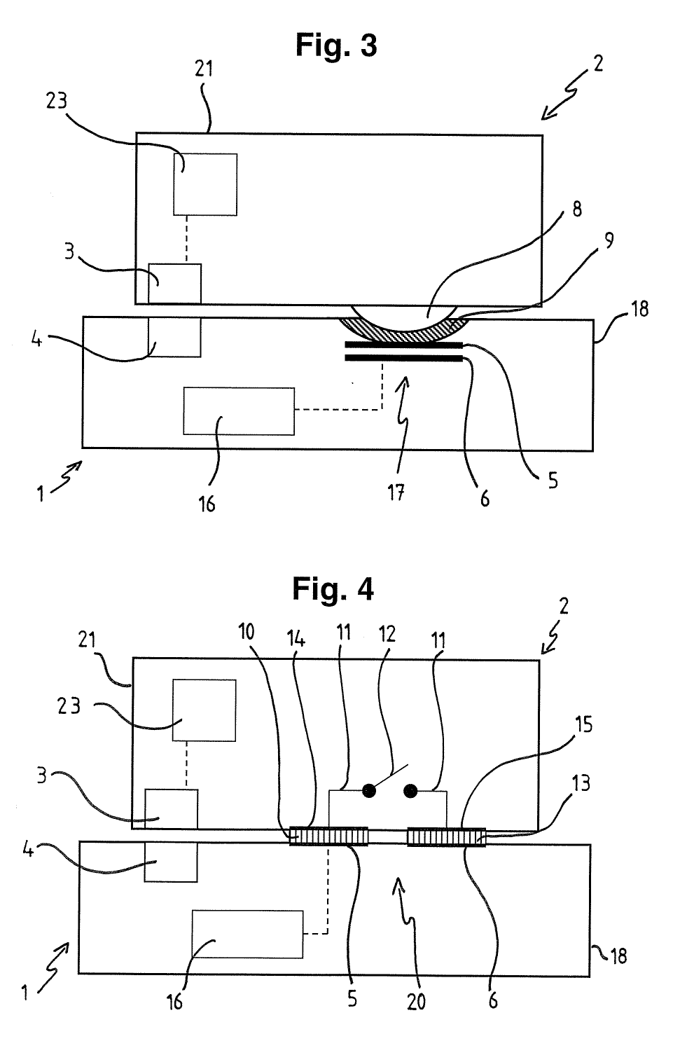

FIG. 3 shows another embodiment of the system. The following will only illustrate the differences with respect to the embodiment from FIG. 1. FIG. 3 also shows a soft area 9 on the surface of the housing 18 of the induction charging device 1, with a first electrode 5 of the capacitor being attached to the inside of said soft area. The second electrode 6 of the capacitor 17 is further arranged on the inside of the housing 18 of the induction charging device 1. The arrangement of the electric toothbrush 2 in the shown charging position means that a mechanism for changing the capacitance, which is once again a housing protrusion 8 in FIG. 3 just as in FIG. 1, mechanically presses onto the soft area 9 and deforms said soft area elastically toward the inside of the housing 18 of the induction charging device in order to change the capacitance. The pressure placed on the soft area 9 and thus on electrode 5 causes electrodes 5 and 6 to come closer together, and the capacitance of the capacitor 17 is increased. The soft area 9 of the housing 18 springs back into the position that it was before the load from the housing protrusion 8 when the electric toothbrush 2 is removed, as is also shown in the embodiment in FIG. 1. The spring effect can be provided by the soft area itself or by an additional spring (not shown). Instead of a separate electrode 5, the electrode 5 can also be a diaphragm made of metal, which forms the soft area 9 itself or a part of it, for example a metallic coating on a soft area, which itself is non-conducting plastic. In one example, the mechanism for changing the capacitance and/or the housing protrusion 8 is shaped such that it does not have any sharp edges that would damage the soft area 9.

FIG. 4 shows another embodiment of the system. As previously, only the differences with respect to FIG. 1 are described. In this embodiment, the capacitor of the induction charging device 1 is designed as an open plate capacitor 20. If the electric toothbrush 9 is not arranged in the charging position shown, the field lines proceed starting from either electrode 5 or electrode 6 essentially in a semicircle to the corresponding electrode 6 or electrode 5. In this embodiment, the electric toothbrush 2 has a capacitive short-circuit mechanism comprising two plate-shaped electrodes 14, 15, which are connected to one another via a connection line 11. As FIG. 4 shows, if the electric toothbrush 2 is then placed in the charging position, electric fields, 10 and 13, form from the electrodes 5, 6 of the capacitor 20 of the induction charging device 1 to the electrodes, 14 and 15, of the electric toothbrush 2. Electrodes 5 and 14 as well as 6 and 15 are arranged opposite one another in the charging position shown. The capacitance of the capacitor 20 thereby changes sharply, and the capacitance change can be detected as a sign of the presence of the toothbrush 2 in the charging position.

Electrodes 14 and 15 of the capacitive short-circuit mechanism of the electric toothbrush 2 are connected to one another via a connection line 11, wherein the connection line 11 can be interrupted by a switch 12. Due to automated actuation of the switch 12, a signal can be transmitted from the mobile electric device 2 to the induction charging device 1. To this end, either alternating voltage is applied to the electrodes, 5 and 6, of the open plate capacitor of the induction charging device 1 and the current flow or the voltage between the electrodes, 5 and 6, is measured, wherein the alternating voltage advantageously has a higher frequency than the data rate of the information, which is digitally coded by the switch 12, or the capacitor comprising electrodes 5 and 6 is connected to a capacitance measuring circuit, wherein its measuring dynamics are advantageously higher than the data rate.

The following describes further embodiments with which an induction charging device can detect whether a mobile electric device is in the charging position. Such a design can be a system, for example, in which the transmitter and the receiver of the optical signals are arranged in the induction charging device. The mobile electric device has a reflector which reflects the signal from the transmitter to the reflector when the mobile electric device is present. The reflector can be configured as a flat reflector. When the mobile electric device is being charged, the reflector is arranged at a point in the mobile electric device opposite the bottom of a depression in the induction charging device to accommodate the mobile electric device. Alternatively, the reflector can be arranged at a point on the mobile electric device, which is opposite one of the side walls of the depression when the mobile electric device is in the depression for charging purposes. The transmitter and/or the receiver are each arranged opposite the reflector in the depression. The reflector can be designed as a retro-reflector, so that the receiver and transmitter, in this case, can be arranged next to one another. In another embodiment, the transmitter and receiver of the optical signals are likewise arranged in the induction charging device, wherein the light transmitted by the transmitter in the mobile electric device enters a curved light guide, which deflects the light by 180° and sends it back to the induction charging device, where the receiver is arranged such that it is hit by the light reflected back. In order to transmit the charging status of the mobile electric device, corresponding information, for example in a code, can be transmitted by an optical transmitter in the mobile electric device via static or flashing light signals.

In another embodiment, a color marking is placed on the mobile electric device, and this color marking is detected by a color detection sensor in the induction charging device, when the mobile electric device is in a charging position.

In another embodiment, the light diode on the mobile electric device indicates its charge status. The transmitted light is detected by a receiver, which is arranged in the induction charging device and signals the presence of the mobile electric device in a charging position.

In another embodiment, the weight force of the mobile electric device is detected by a piezoelectric element or with a contact mat, either of which is arranged in the induction charging device.

In addition, the mobile electric device can have an electromagnetic transponder (RFID tag), which is queried by a query mechanism in the induction charging device. A response from the RFID tag indicates that the mobile electric device is in its charging position.

In yet another embodiment, an ultrasound receiver is arranged on the induction charging device and an ultrasound transmitter is arranged on the mobile electric device. This enables the induction charging device to monitor whether ultrasound signals are being transmitted by the mobile electric device. The result of the monitoring is a signal that indicates the presence of the mobile electric device in the charging position when ultrasound signals are being received. The signals can be coded so that other ultrasound signals can only trigger the signal with a low level of probability. In addition, the mobile electric device can transmit data to the induction charging device via the ultrasound connection. The communication can take place through the air. The transmitter and receiver may contain piezo material as a converter between the electric signals and ultrasound signals.

In another embodiment, ultrasound signals from the mobile electric device are coupled to a solid structure as a transmission element for ultrasound signals. Said element makes contact with a receiver or another transmission element for ultrasound, which forms a part of the induction charging device, and is connected with an ultrasound receiver such that the ultrasound is transmitted to it. If the mobile electric device is placed in the charging position, this procedure establishes a connection between the mobile electric device and the induction charging device for ultrasound signals via the aforementioned elements. The ultrasound is then transmitted via solid-structure-borne sound. Advantageously, the connection for the ultrasound signals between the ultrasound transmitter and the ultrasound detector is executed stiffly enough and/or with low damping, particularly at the connection point that is separated when the mobile electric device is removed from a charging position, such that the reception of ultrasound signals is possible at the receiver.

An induction charging device and a mobile electric device can be equipped with an additional pair of corresponding coils. Via these coils, a signal can be transmitted from the mobile electric device to the induction charging device which shows that the mobile electric device is in a charging position. In addition, information can be transmitted in both directions via the corresponding coils. The additional pair of coils is preferably operated at frequency that is different than that used for energy transmission to prevent malfunctions. Advantageously, the frequency of the additional coils is not an integer multiplier or a fraction with a small integer divisor such as, for example, a half, third, fourth, fifth, etc. of the frequency of the energy transmission.

In another configuration, a separate coil is added to the induction charging device, in addition to the coil for energy transmission. A material, for example, a ferrite core, is arranged in the mobile electric device and said material can be used to change the inductivity of the separate coil. The coil is preferably arranged in the induction charging device such that the ferrite core or the like is located in the vicinity of the coil when the mobile electric device is arranged in a charging position. Instead of a ferrite core, another ferromagnetic, particularly magnetically soft, material can be used, e.g. iron, steel, nickel, or cobalt, or an alloy with one of these materials. The separate coil can also be designed with measuring electronics so that the evaluation circuit reacts to energy loss due to eddy currents outside of the coil. This is the prior art for metal detectors. A piece of metal or another electrically conducting material can be arranged in or on the mobile electric device and this piece is located in an area in which the separate coil triggers eddy currents in the conducting material when the mobile electric device is in a charging position.

A fluxgate magnetometer can be arranged in the induction charging device, wherein a material with a significant remnant induction, for example, a permanent magnetic material, is arranged in the mobile electric device. Advantageously, the material with the remnant induction is arranged in the detection area of the fluxgate magnetometer, so that signal changes on said magnetometer indicate the presence of the mobile electric device in a charging position. In one embodiment, a coil is arranged in the mobile device, which generates a magnetic field. This magnetic field is advantageously measured by the fluxgate magnetometer or with a Hall probe. Advantageously, information can be transmitted from the mobile electric device to the induction charging device by varying the strength of the magnetic field. The information is advantageously present as digital data on the fluxgate magnetometer or the Hall probe.

In another embodiment, a separate coil with a moving core is arranged in the induction charging device, and said core is moved by the weight of the mobile electric device when it is in a charging position and the separate coil is detuned. This detuning can be detected with a corresponding receiver circuit and used as a signal for the presence of the mobile electric device in a charging position.

In another embodiment, a mechanical switch is arranged in the induction charging device and said switch is actuated by the weight of the mobile electric device when it is in a charging position. The switch can be located under a soft area on the surface of the induction charging device, wherein the soft area is deformed when the switch is actuated. The electric switch switches on energy transmission when the mobile electric device is in the charging position and switches off energy transmission when the mobile electric device is not in a charging position. The effect of the weight force of the mobile electric device can be enhanced by arranging the switch in the wall of a wedge- or cone-shaped force enhancement device into which a corresponding counter-wedge, which forms a part of the mobile electric device, is inserted. This also increases reliability in that it will not be unintentionally triggered when subjected to vibrations.

The induction charging device can have a soft area on its surface through which the weight force of the mobile electric device is transferred to a strain gauge, which is arranged in the interior of the induction charging device. The presence of the mobile electric device in the induction charging device can be detected by means of the change in the properties of the strain gauge.

In another embodiment, a capacitor is in the mobile electric device, and said capacitor forms an oscillatory circuit with a coil, which is also arranged in the mobile electric device, wherein the coil interacts magnetically with a second coil in the induction charging device. The coil in the induction charging device is integrated into an oscillatory circuit. The capacitor in the mobile electric device is designed and connected such that it influences the oscillatory circuit in the induction charging device so that it no longer oscillates. Due to the ending of oscillation, a determination can be made in the induction charging device as to whether the mobile electric device is in the charging position. Advantageously, the effect of the capacitor and the mobile electric device is switchable, so that, by means of actuation of the corresponding switching function, data can be transferred due to switch-on and switch-off of the oscillator in the induction charging device.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An induction charging device for charging an energy accumulator of a mobile electric device comprising:
a coil for energy transmission; and
a control for energy transmission, wherein the control is connected to a capacitor with a modifiable capacitance, wherein the capacitor is designed such that its capacitance changes as a function of whether the mobile electric device is in a charging position or not.

2. The induction charging device according to claim 1, wherein the capacitor includes at least two electrodes, wherein a dielectric extends, at least partially, between the electrodes, and the dielectric's constant can be modified by exertion of a force or the effects of a field on the dielectric, wherein the force or the field depends on whether the mobile electric device is in the charging position or not.

3. The induction charging device according to claim 1, wherein the capacitor includes at least two electrodes, wherein a dielectric extends, at least partially, between the electrodes, wherein the dielectric is, at least partially, exchangeable, and wherein the dielectric that is between the electrodes depends on whether the mobile electric device is in the charging position or not.

4. The induction charging device according to claim 1, wherein the capacitor has at least two electrodes whose relative position with respect to one another and/or whose form can be modified, wherein the relative position and/or form depends on whether the mobile electric device is in the charging position or not.

5. The induction charging device according to claim 1, further comprising a housing, wherein the capacitor with at least two electrodes and a dielectric is arranged in the housing and wherein the housing has a deformable section, which makes it possible to exert force from the exterior onto the dielectric or onto at least one of the electrodes.

6. The induction charging device according to claim 1, further comprising a housing, wherein the capacitor with at least two electrodes is arranged in a housing, wherein the housing is designed such that a depression, which is accessible from the exterior, is provided between the electrodes, and a section of the mobile electric device can be placed into said depression.

7. The induction charging device according to claim 1, further comprising a housing, wherein the capacitor is designed as an open plate capacitor with at least two electrodes, wherein the electric field of the capacitor extends, at least partially, outside of the housing when the mobile electric device is in operation.

8. The induction charging device according to claim 1, wherein the control is configured such that it detects the capacitance of the capacitor during operation of the device and controls energy transmission as a function of the capacitance of the capacitor.

9. A system comprising:
an induction charging device including a coil for energy transmission and a control for energy transmission; and
a mobile electric device including a coil for energy transmission and an energy accumulator connected to the coil,
wherein the control is connected to a capacitor with a modifiable capacitance; and wherein the mobile electric device can be positioned in a charging position such that, with the assistance of the coils, energy can be transferred from the induction charging device to the energy accumulator of the mobile electric device, and wherein the mobile electric device has a mechanism which changes the capacitance of the capacitor of the induction charging device depending on whether the mobile electric device is in the charging position or not.

10. The system according to claim 9, wherein the mobile electric device comprises a housing, wherein the mechanism for changing the capacitance is a flexible section of the housing, which, when the mobile electric device is in the charging position, latches onto the flexible section of the housing of the induction charging device and exerts a force onto at least one electrode or a dielectric of the capacitor.

11. The system according to either claim 9, wherein the mobile electric device comprises a housing, wherein the mechanism for changing the capacitance is a section of the housing, which, when the induction charging device is in the charging position, latches onto a depression in the housing of the induction charging device.

12. The system according to claim 11, wherein when the induction charging device is in the charging position, the mechanism for changing the capacitance is located in the field of the capacitor.

13. A process for charging an energy accumulator of a mobile electric device comprising the steps of:
providing an induction charging device with a control for energy transmission;
detecting the capacitance of a capacitor of the induction charging device, which depends on the presence of the mobile electric device in the environment of the induction charging device;
comparing the capacitance results with a threshold value; and
activating or deactivating energy transmission between a coil of the induction charging device and the mobile electric device as a function of the results of the comparison.
